(19) United States
(12) Patent Application Publication
(10) Pub. No.: US 2013/0124902 A1
(43) Pub. Date: May 16, 2013

(54) MONITORING GPU SOCKET DEGRADATION

(71) Applicant: Jihua Yu, Shenzhen (CN)

(72) Inventor: Jihua Yu, Shenzhen (CN)

(73) Assignee: NVIDIA CORPORATION, Santa Clara, CA (US)

(21) Appl. No.: 13/419,344

(22) Filed: Mar. 13, 2012

(30) Foreign Application Priority Data
Nov. 10, 2011 (CN) 201110353235.5

(51) Int. Cl. G06F 1/26

(52) U.S. Cl. 713/340

(57) ABSTRACT

In various embodiments, a circuit and method for monitoring graphics processing unit (GPU) socket degradation is provided. One embodiment comprises: monitoring a voltage delta between a NVVDD voltage conduction point and a NVVDD voltage direct-detection point in a GPU socket; and determining whether the voltage delta is more than a predetermined value. With the present embodiment, the surveillance of the GPU socket degradation can be realized, avoiding continuing to use the GPU socket when it is overly degraded.

### CROSS-REFERENCE TO RELATED APPLICATION

This patent application claims the benefit and priority of the co-pending Chinese Patent Application No. 201110353235.5, by Jihua Y U, filed on Nov. 10, 2011, Attorney Docket Number P2011170, which is hereby incorporated by reference.

### BACKGROUND

Graphics processing unit (GPU) products must undergo a series of tests before delivery in order to guarantee quality, which tests include a Socket Level Test (SLT). Particularly, the SLT can be implemented via inserting a GPU to be tested into a GPU socket to execute the related tests.

However, with the increased times of GPU insertion, the performance of the GPU socket degenerates gradually due to wear. When the GPU socket degradation reaches a certain level, a false GPU testing result may be made if the GPU socket is not replaced in time by its user. For example, a “fake failure” can occur. That is, even if the GPU to be tested is a qualified product, a testing result showing that it is unqualified will be obtained because of the GPU socket degradation and the user may process the qualified product as a defective product.

### SUMMARY

Therefore, there is a need to provide a solution for monitoring GPU (graphics processing unit) socket degradation to solve the above problems. Various embodiments in accordance with the present invention relate to a circuit and a method for monitoring GPU socket degradation to realize surveillance of the GPU socket degradation and thus control it.

One embodiment of the invention includes a circuit for monitoring GPU socket degradation comprising: a first input end coupled to a NVVDD voltage conduction point of a GPU socket to obtain a first NVVDD voltage of a GPU to be tested conducted by the GPU socket; a second input end coupled to a NVVDD voltage direct-detection point of the GPU socket to obtain a second NVVDD voltage of the GPU to be tested directly from the pins of the GPU to be tested; a monitoring chip coupled respectively with the first input end and the second input end, the monitoring chip is implemented to monitor the voltage delta between the first input end and the second input end and transfer it through an output end.

In an embodiment, the NVVDD voltage conduction point is located on a printed circuit board on which the GPU socket is installed.

In an embodiment, the circuit is located on a printed circuit board on which the GPU socket is installed.

In an embodiment, the monitoring chip is an analog-to-digital convertor.

In an embodiment, the first input end is coupled to a positive terminal of the monitoring chip and the second input end is coupled to a negative terminal of the monitoring chip. Alternatively, in one embodiment, the first input end is coupled to the negative terminal of the monitoring chip and the second input end is coupled to the positive terminal of the monitoring chip.

In an embodiment, the circuit further comprises a control chip coupled to the output end of the monitoring chip. The control chip is implemented to determine whether the voltage delta is more than a predetermined value so as to control excessive degradation of the GPU socket.

In an embodiment, the circuit further comprises an alarm coupled to the control chip, wherein the alarm can be triggered by the control chip when the voltage delta is more than the predetermined value.

In an embodiment, the alarm is a software alarm or a hardware alarm.

In an embodiment, the hardware alarm is a buzz alarm or a flashing light-emitting diode (LED) alarm.

In an embodiment, the circuit further comprises a display coupled to the control chip. The display is implemented to show the voltage delta in real time.

Another embodiment of the present invention includes a method for monitoring GPU socket degradation comprising: monitoring a voltage delta between a NVVDD voltage conduction point and a NVVDD voltage direct-detection point of a GPU socket; and determining whether the voltage delta is more than a predetermined value.

In an embodiment, the NVVDD voltage conduction point is located on a printed circuit board on which the GPU socket is installed.

In an embodiment, the method is implemented by a special circuit located on a printed circuit board on which the GPU socket is installed.

In an embodiment, the step of monitoring the voltage delta further comprises a step of performing analog-to-digital conversion on the voltage delta.

In an embodiment, the method further comprises a step of sending an alarm after determining that the voltage delta is more than the predetermined value.

In an embodiment, the step of sending the alarm can be implemented in the form of hardware or software.

In an embodiment, the method further comprises a step of showing the voltage delta in real time.

One embodiment in accordance with the present invention includes a circuit comprising a first input of a chip coupled to obtain a first voltage of a graphics processing unit (GPU) to be tested. In addition, the circuit comprises a second input of the chip coupled to obtain a second voltage of the GPU to be tested. Furthermore, the chip is configured to detect a voltage delta between the first voltage and the second voltage and transfer an output.

Another embodiment in accordance with the present invention includes a method comprising detecting a voltage delta between a first voltage of a GPU to be tested and a second voltage of the GPU to be tested. Additionally, the method comprises determining whether the voltage delta is more than a predetermined value.

With the technical solutions of various embodiments of the present invention, monitoring the performance of a GPU socket can be achieved and controlled, and thus avoid continued use of an excessively degraded GPU socket.

Additional features and advantages of various embodiments in accordance with the invention will be set forth in the description that follows, and in part will be apparent from the description, or may be learned by practice of various embodiments in accordance with the invention. The advantages of various embodiments in accordance with the invention will be realized and attained by the structures particularly pointed out in the written description and claims hereof as well as the appended drawings.

It is to be understood that both the foregoing general description and the following detailed description are exemplary and explanatory and are intended to provide further explanation of the invention as claimed.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings are included to provide a further understanding of various embodiments in accordance with the invention, and are incorporated in and constitute a part of this specification. The drawings illustrate various embodiments of the invention and, together with the description, serve to explain principles of various embodiments in accordance with the invention.

FIG. 1A illustrates a diagram of an environment to which a circuit for monitoring GPU socket degradation is applied, in accordance with an exemplary embodiment of the present invention.

FIG. 1B illustrates a functional block diagram of a circuit for monitoring GPU socket degradation, in accordance with an exemplary embodiment of the present invention.

FIG. 1C illustrates a schematic of using a circuit for monitoring GPU socket degradation, in accordance with an exemplary embodiment of the present invention.

FIG. 2 illustrates a flow chart of a method for monitoring GPU socket degradation, in accordance with an exemplary embodiment of the present invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details or with equivalents thereof. In other instances, well known methods, procedures, components, and circuits have not been described in detail as not to unnecessarily obscure aspects of the invention.

Various example embodiments are described herein in the context of a circuit and method for monitoring GPU (graphics processing unit) socket degradation. Those of ordinary skill in the art will realize that the following description is illustrative only and is not intended to be in any way limiting. Other embodiments will readily suggest themselves to those skilled in the art having the benefit of this disclosure. Reference will now be made in detail to implementations of the example embodiments as illustrated in the accompanying drawings. The same reference indicators will be used to the extent possible throughout the drawings and the following description to refer to the same or like items.

Various embodiments in accordance with the present invention relate generally to circuit technology and, in particular, to a circuit for monitoring GPU socket degradation and a method for monitoring GPU socket degradation.

Reference will now be made in detail to various embodiments in accordance with the present invention, examples of which are illustrated in the accompanying drawings.

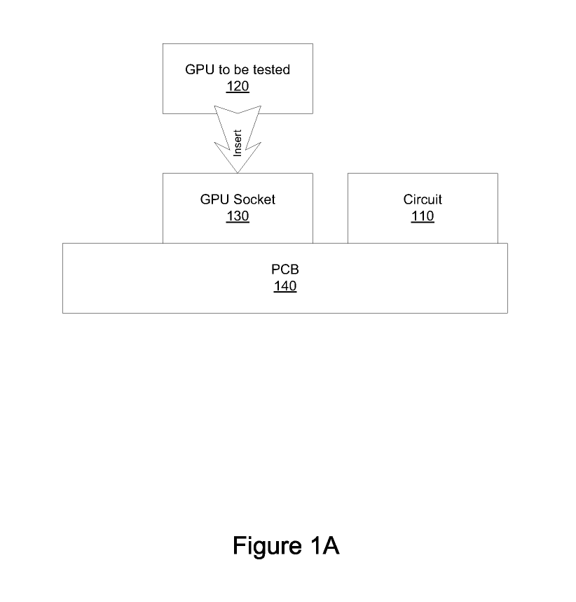

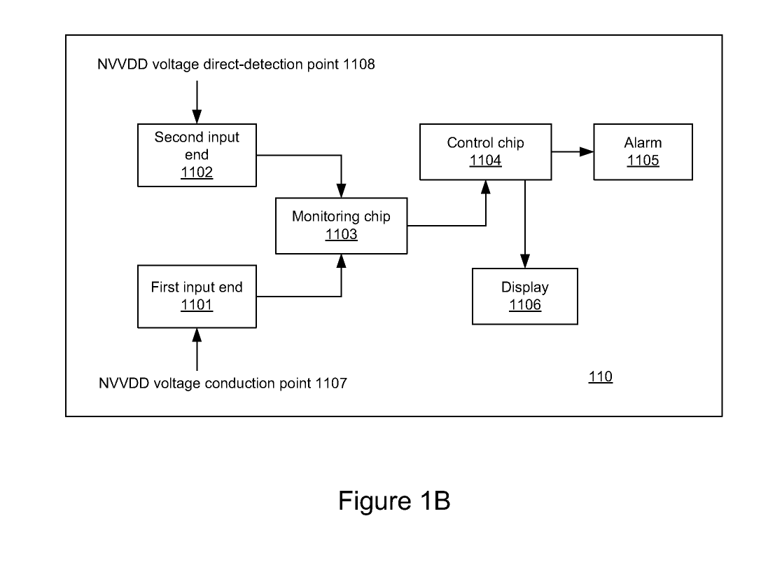

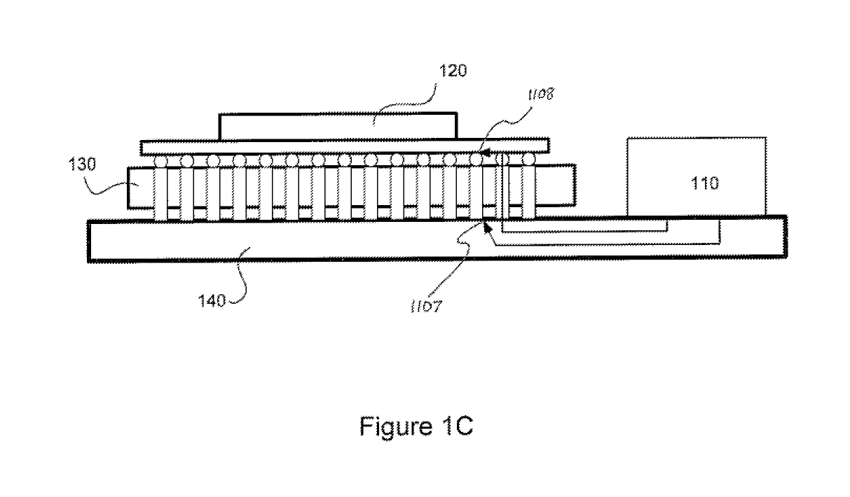

FIG. 1A illustrates a diagram of an environment to which a circuit for monitoring GPU socket degradation is applied, in accordance with an exemplary embodiment of the present invention. An embodiment in accordance with the present invention includes a circuit 110 for monitoring the GPU socket degradation.

As shown in FIG. 1A, in an embodiment, during the process of Socket Level Test (SLT), a GPU to be tested 120 is inserted into a GPU socket 130, which is installed on a printed circuit board (PCB) 140. Thus, various electric parameters of the GPU to be tested 120 can be measured from the GPU socket 130 and be transferred to a test control console (not shown) through a connection point between the GPU socket 130 and the PCB 140, including transferring the NVVDD voltage of the GPU to be tested 120. In an embodiment of the present invention, the circuit 110 for monitoring the GPU socket degradation can be located on the PCB 140 that the GPU socket 130 is installed.

FIG. 1B illustrates a functional block diagram of a circuit 110 for monitoring GPU socket degradation, in accordance with an exemplary embodiment of the present invention. As shown in FIG. 1B, the circuit 110 comprises a first input end 1101 coupled to a NVVDD voltage conduction point 1107 of the GPU socket 130 to obtain a first NVVDD voltage of the GPU to be tested 120 when conducted by the GPU socket 130. As such, after the GPU socket 130 conducts the NVVDD voltage of the GPU to be tested 120, it can be measured at the NVVDD voltage conduction point 1107. In an embodiment, the NVVDD voltage conduction point 1107 is a copper solder joint on the PCB 140 on which the GPU socket 130 is installed and is under the GPU socket 130.

In an embodiment, the circuit 110 comprises a second input end 1102 coupled to a NVVDD voltage direct-detection point 1108 of the GPU socket 130 to directly obtain a second NVVDD voltage of the GPU to be tested 120 from the pins of the GPU to be tested 120. Particularly, in one embodiment, the second input end 1102 is coupled to the position in the GPU socket 130 where the NVVDD voltage die sense pin of the GPU 120 can be touched after the GPU to be tested 120 is inserted. That is, when the GPU to be tested 120 is inserted into the GPU socket 130, the second input end 1102 can touch the NVVDD voltage die sense pin of the GPU to be tested 120.

In an embodiment, the circuit 110 comprises a monitoring chip 1103 coupled respectively with the first input end 1101 and the second input end 1102, and is implemented to monitor the voltage delta between the first input end 1101 and the second input end 1102 and transfer it through an output end. As a specific embodiment, the monitoring chip 1103 can be an analog-to-digital convertor (ADC) so that the detected voltage delta can be transferred digitally. As another specific embodiment, the first input end 1101 is coupled to the positive terminal of the monitoring chip 1103 and the second input end 1102 is coupled to the negative terminal of the monitoring chip 1103, or vice versa.

In an embodiment, taking an ADC whose model is ADS1112 as an example, its positive terminal is coupled to the copper solder joint 1107 under the GPU socket 130 from which the NVVDD voltage of the GPU 120 is conducted, and its negative terminal is coupled to the position where the NVVDD voltage die sense pin of the GPU 120 can be touched after the GPU 120 is inserted into the GPU socket 130. Therefore, the users can monitor the voltage delta between the PCB 140 and the pin of the GPU 120 and use it as an indication of the degradation.

In order to realize a control function, the circuit 110 of an embodiment of the present invention may further comprise a control chip 1104 coupled to the output end of the monitoring chip 1103. In an embodiment, the control chip 1104 includes a control program or test software to determine whether the voltage delta is more than a predetermined value. Optionally, the circuit 110 of an embodiment of the present invention may further comprise an alarm 1105 coupled to the control chip 1104. In an embodiment, the alarm 1105 can be triggered by the control chip 1104 when the voltage delta is more than the predetermined value. In a specific embodiment, the alarm 1105 can be a software alarm, such as an alarm program embedded into the control chip 1104, which can produce an alarm prompt when the voltage delta is more than the predetermined value. In another specific embodiment, the alarm 1105 can be a hardware alarm, such as a buzz alarm, a flashing light-emitting diode (LED) alarm, and the like.

In an embodiment, still taking the ADC whose model is ADS1112 as an example, an example is provided as follows: the test software of the control chip 1104 reads the digital voltage delta from the ADS1112. Under a given current (for example, 100 A (amperes)), the control chip 1104 will warn the operator that the GPU socket 130 should be replaced with a new one if the voltage delta is more than the predetermined value (for example, 20 mV (millivolts)).

The circuit 110 in accordance with an embodiment of the present invention may further comprise a display 1106 coupled to the control chip 1104 to show the voltage delta in real time.

For easy understanding, a specific embodiment of using the circuit 110 for monitoring the GPU socket degradation is shown in FIG. 1C. It can be seen that a GPU to be tested 120 is inserted into a GPU socket 130. The GPU socket 130 is installed on a printed circuit board (PCB) 140 and an analog-to-digital convertor (ADC) device 110 is installed on the PCB 140. One of the two input ends of the ADC device 110 is coupled to the NVVDD voltage conduction point 1107 of the GPU socket 130 on the PCB 140, and another is coupled to the NVVDD voltage direct-detection point 1108 so that the voltage delta between the two input ends can be monitored.

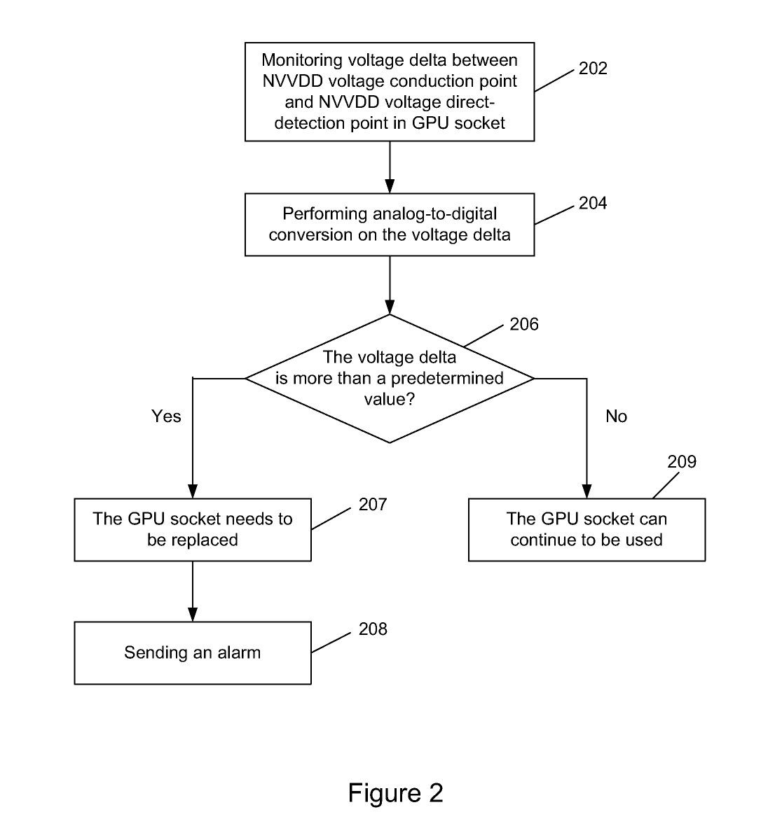

FIG. 2 illustrates a method for monitoring GPU socket degradation, in accordance with an exemplary embodiment. In an embodiment, the method can be implemented by a circuit for monitoring GPU socket degradation in accordance with an embodiment of the present invention. In one embodiment, the circuit can be located on a printed circuit board (PCB) on which a GPU socket is installed. The method comprises the following steps.

At step 202, a voltage delta is monitored between a NVVDD voltage conduction point and a NVVDD voltage direct-detection point of a GPU socket. In an embodiment, after the GPU socket conducts the NVVDD voltage of the GPU to be tested, it can be measured at the NVVDD voltage conduction point as the first NVVDD voltage of the GPU to be tested. In an embodiment, the NVVDD voltage direct-detection point is coupled to the NVVDD voltage die sense pin of the GPU to be tested which has been inserted into the GPU socket. In this manner, a second NVVDD voltage of the GPU to be tested is obtained directly from the pin of the GPU to be tested. In an embodiment; the NVVDD voltage conduction point can be located on the PCB on which the GPU socket is installed.

At step 204, an analog-to-digital conversion is performed on the voltage delta. In an embodiment, as an optional step, the aim of the step is to transfer the detected voltage delta digitally to facilitate subsequent comparison and control.

At step 206, it is determined whether the voltage delta is more than a predetermined value. If yes, the GPU socket needs to be replaced as indicated by step 207 and as an optional step, step 208 can be executed. Otherwise, the GPU socket can continue to be used as indicated by 209.

At step 208, an alarm is sent to prompt an operator to replace the GPU socket. As specific embodiments, the step 208 of sending the alarm can be implemented in the form of hardware or software, wherein the hardware form can be realized in a buzz way or a flashing LED way.

Moreover, optionally, a step of showing (in an analog or digital format) the detected voltage delta in real time can be provided after the step 202 or the step 204.

According to the above exemplary embodiments, it can be seen that with the circuit and the method for monitoring GPU socket degradation provided by the present invention, the surveillance of the GPU socket degradation can be realized and further the corresponding control can be processed. Thus, the GPU socket can be replaced in time before its degradation interferes with the GPU test results, so that the GPU test errors caused by the GPU socket degradation can be effectively avoided.

It should be appreciated that various modifications, adaptations and alternative embodiments thereof may be made within the scope and spirit of the present invention. The invention is further defined by the following claims.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A circuit comprising:
a first input of a chip coupled to obtain a first voltage of a graphics processing unit (GPU) to be tested;
a second input of the chip coupled to obtain a second voltage of the GPU to be tested; and
the chip is configured to detect a voltage delta between the first voltage and the second voltage and transfer an output.

2. The circuit of claim 1, wherein the chip is an analog-to-digital convertor.

3. The circuit of claim 1, further comprising:
a control chip coupled to receive the output from the chip, the control chip configured to determine whether the voltage delta is more than a predetermined value.

4. The circuit of claim 3, wherein the chip is an analog-to-digital convertor.

5. The circuit of claim 3, further comprising:
a display coupled to the control chip, the display configured to show the voltage delta.

6. The circuit of claim 3, further comprising:
an alarm coupled to the control chip, the alarm is triggered by the control chip after determining the voltage delta is more than the predetermined value.

7. The circuit of claim 6, wherein:
the GPU is within a GPU socket; and
the triggered alarm indicates the GPU socket is to be replaced.

8. A method comprising:
detecting a voltage delta between a first voltage of a graphics processing unit (GPU) to be tested and a second voltage of the GPU to be tested; and
determining whether the voltage delta is more than a predetermined value.

9. The method of claim 8, wherein the detecting further comprises performing an analog-to-digital conversion on the voltage delta.

10. The method of claim 8, further comprising:
triggering an alarm after determining that the voltage delta is more than the predetermined value.

11. The method of claim 10, wherein the detecting further comprises performing an analog-to-digital conversion on the voltage delta.

12. The method of claim 10, wherein:
the GPU to be tested is within a GPU socket; and
the triggered alarm indicates the GPU socket is to be replaced.

13. The method of claim 8, further comprising:
displaying the voltage delta in real time.

14. The method of claim 8, wherein the second voltage is obtained from a pin of the GPU to be tested.

15. A circuit comprising:
a first input of a monitoring chip coupled to obtain a first voltage of a graphics processing unit (GPU) to be tested within a GPU socket;
a second input of the monitoring chip coupled to a pin of the GPU to be tested to obtain a second voltage of the GPU to be tested; and
the monitoring chip is configured to monitor a voltage delta between the first input and the second input and transfer an output.

16. The circuit of claim 15, further comprising:
a control chip coupled to receive the output from the monitoring chip, the control chip configured to determine whether the voltage delta is more than a predetermined value.

17. The circuit of claim 16, further comprising:
an alarm coupled to the control chip, wherein the alarm is triggered by the control chip after it is determined the voltage delta is more than the predetermined value.

18. The circuit of claim 17, wherein the triggered alarm indicates the GPU socket is to be replaced.

19. The circuit of claim 17, wherein the alarm comprises a software alarm.

20. The circuit of claim 17, wherein the alarm comprises a hardware alarm.
